(19) United States
(12) Patent Application Publication
(10) Pub. No.: US 2022/0018481 A1
(43) Pub. Date: Jan. 20, 2022

(54) Compression Ring Apparatus and Method for Sealing a Pipe Liner

(71) Applicant: Core Linepipe Inc., Calgary (CA)

(72) Inventors: GREGORY MICHAEL HENRY, Didsbury (CA); WEI-EN CHEN, Calgary (CA); MATTHEW FRANK BEER, Chestermere (CA)

(21) Appl. No.: 17/374,543

(22) Filed: Jul. 13, 2021

Related U.S. Application Data
(60) Provisional application No. 63/052,012, filed on Jul. 15, 2020.

(51) Int. Cl. F16L 55/163; F16L 55/165

(52) U.S. Cl. CPC F16L 55/163; F16L 55/165

(57) ABSTRACT

A sealing compression ring apparatus couplable to a liner and a pipe component has an annular body and a bore, with a first side including a raised outer edge portion, a recessed annular portion between the raised outer edge portion and the bore, and an o-ring gland encircling the bore on the recessed annular portion. A pipe assembly has a base pipe including a flange, a liner extending axially within the base pipe and extending radially out and over a portion of the flange to define a liner flange, an opposite flange surface, and a sealing compression ring apparatus compressed between the flange and the opposite flange surface, and an o-ring positioned in the o-ring gland of the ring.

### TECHNICAL FIELD

The present invention relates to ring seals in general, and compression ring seals for pipes in particular.

### BACKGROUND

Traditionally polymeric liners, such as those lining pipes, have relied on compression of a flange end face of the liner with an opposite face surface, such as another, mating liner flange end face, a standard pipe flange or an end cap, in order to create a sealing interface. A pipe flange, as will be appreciated, is an annular plate-like extension from the end of the pipe. The compression force is provided by compression fasteners acting through the pipe flange and the structure to which it is attached. Such compression fasteners may be, for example, bolts acting through bolt holes in the pipe flange. The pipe flange applies pressure against the liner flange so that its end face is compressed against the opposing face surface. A liner flange has a material strength that is weaker than steel so a steel ring is needed to limit the amount of compression such that the liner flange is not extruded out from compressive forces. This method works until creep reduces the interface pressure below the sealing requirement. Elastomers are more creep resistant, so using an o-ring at the liner flange end face has been desired to eliminate this issue. Unfortunately there are some challenges for example, o-ring grooves will creep away if cut into the liner plastic making replacement impossible; and o-rings located outside the liner flange interface area may prevent leaks to the exterior, but will not contain primary leaks from the liner.

### SUMMARY OF INVENTION

In accordance with a broad aspect of the present invention, there is provided a sealing compression ring apparatus couplable to a liner and a pipe component, comprising: a body, being substantially annular, having a first side, a second side, and a bore extending from the first side to the second side; the first side including: a raised outer edge portion; a recessed annular portion between the raised outer edge portion and the bore; and an o-ring gland encircling the bore on the recessed annular portion.

In accordance with another broad aspect of the present invention, there is provided a pipe assembly, comprising: a base pipe including a flange having a planar face; a liner extending axially within the base pipe and extending radially out and over a portion of the flange to define a liner flange; an opposite flange surface connected by compression fasteners to the flange; and a sealing compression ring apparatus compressed between the flange and the opposite flange surface, the sealing compression ring including a body, being substantially annular, having a first side, a second side, and a bore extending from the first side to the second side; the first side including: a raised outer edge portion; a recessed annular portion between the raised outer edge portion and the bore; an o-ring gland encircling the bore on the recessed annular portion; and an o-ring positioned in the o-ring gland; the raised outer edge portion being in contact with the flange and the o-ring compressed between the liner flange and the recessed annular portion.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

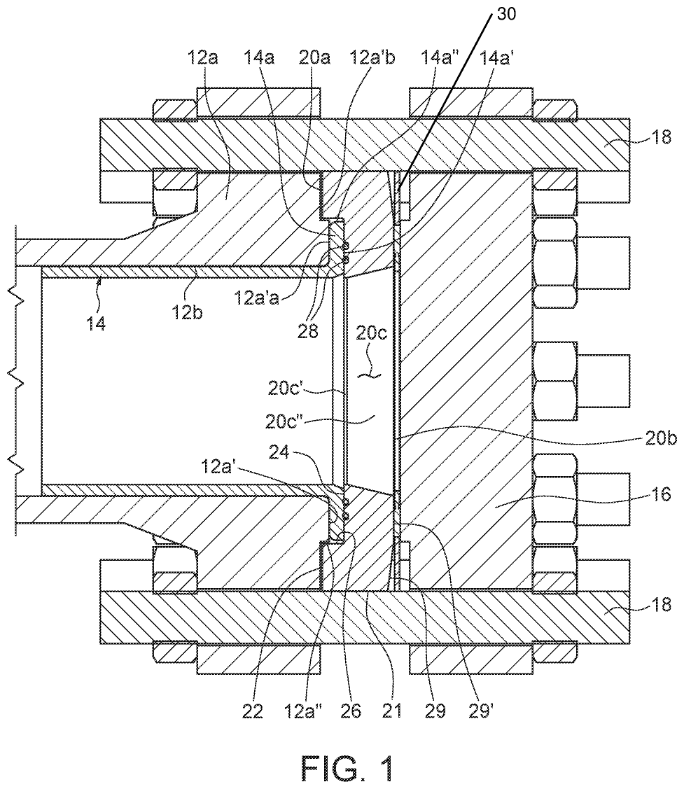

(a) FIG. 1 is a cross sectional side view of a sealing compression ring assembly according to one embodiment of the present invention;

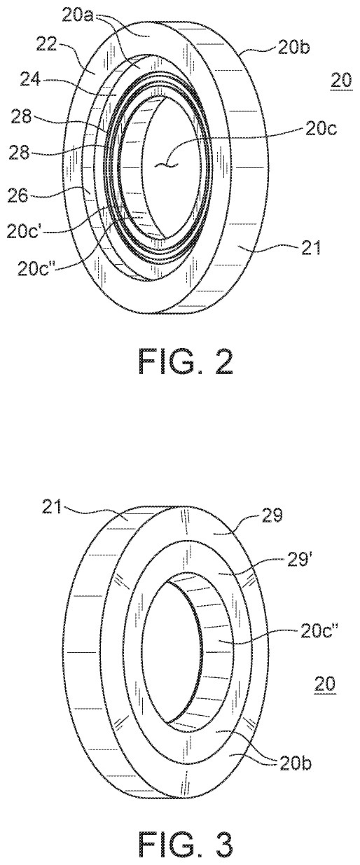

(b) FIG. 2 is a front perspective view of the sealing compression ring of the assembly of FIG. 1;

(c) FIG. 3 is a rear perspective view of the sealing compression ring of FIG. 2;

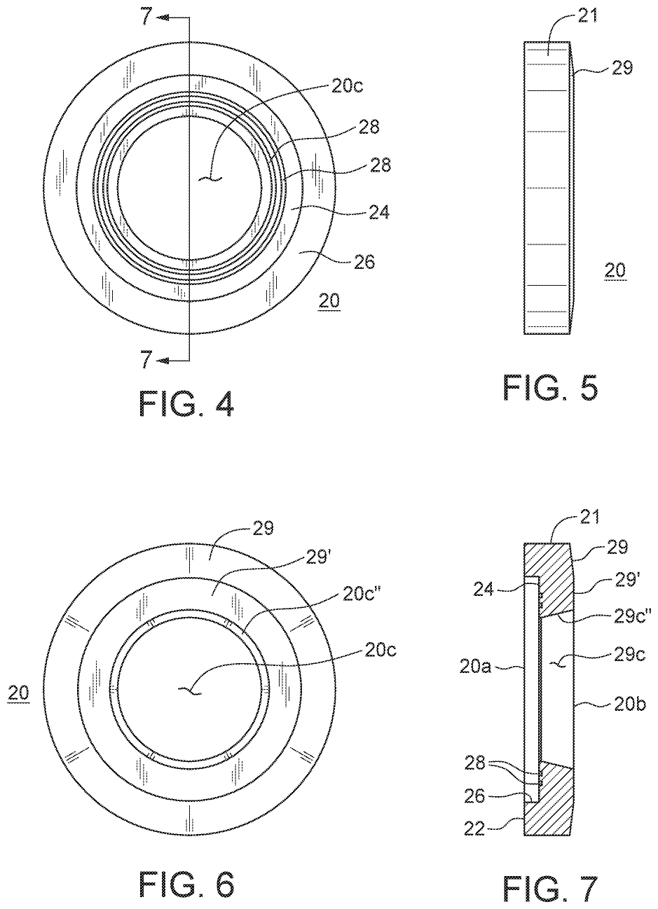

(d) FIG. 4 is a front elevation view of the sealing compression ring of FIG. 2;

(e) FIG. 5 is a side elevation view of the sealing compression ring of FIG. 2;

(f) FIG. 6 is a rear elevation view of the sealing compression ring of FIG. 2;

(g) FIG. 7 is a cross-sectional view of the sealing compression ring of FIG. 2 along line 7-7 of FIG. 4;

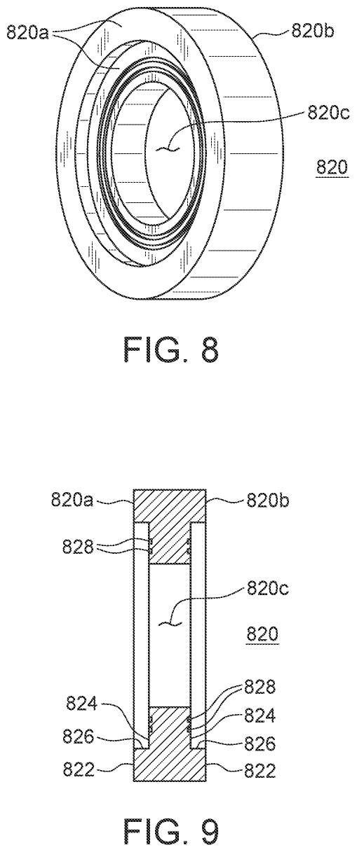

(h) FIG. 8 is a front perspective view of a sealing compression ring according to another embodiment of the present invention; and

(i) FIG. 9 is a cross-sectional view of the sealing compression ring of FIG. 8.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

A compression ring has been invented for use to provide primary containment at a polymeric flange end face. The ring is for sealing a plastic liner to another plastic liner or the plastic liner to a standard flange.

A sealing compression ring includes faces for sealing a plastic liner flange of a pipe to a standard gasket, another pipe flange or an opposite plastic flange, while limiting damaging compression of the aforementioned plastic flange. The ring is designed to include sealing elements (such as o-rings) of a different material from the flange to address degradation of interface pressure to the plastic flange from various causes.

With reference to FIG. 1, a lined pipe 10 includes a base pipe 12 and a liner 14 extending within an inner diameter 12b of the base pipe. At an end of the lined pipe, the base pipe has a pipe flange 12a with a planar face 12a′. The liner extends out and over a portion of the pipe flange, creating a liner flange 14a. The liner flange has an exposed end face 14a′ that is substantially planar. The thickness of the liner flange creates an annular shoulder 14a″ that creates a step between the pipe flange face 12a′ and liner end face 14a′.

When installed, the pipe flange 12a is connected to another flange-type component 16 (which may be a substantially planar member) such as by bolts 18. The connection of pipe flange 12a to another component 16 by bolts creates compressive force therebetween that seals liner flange 14a against a mating surface by compression. While prior mating surfaces may be another plastic liner flange or a pipe flange, in the present invention the lined pipe 10 is compression sealed against a compression ring 20. The compression ring may be used, for example, to provide primary containment at the polymeric liner flange end face 14a′. The ring is positioned as an insert between the lined pipe 10 flanges 12a, 14a and flange-type component 16.

Ring 20 may be substantially annular, having a first side 20a and a second side 20b, an axial bore 20c that extends from the first side to the second side, and an outer cylindrical wall 21. The first side 20a is configured for sealing against the flanged end face of a lined pipe, while the second side 20b is configured for sealing against another component 16. While the first side 20a is reasonably consistent, the second side can vary depending on the form of the component 16 against which it is sealed.

The first side 20a, for example, may include a raised outer edge face 22 and a recessed inner face 24 with a step 26 therebetween. Recessed inner face 24 directly encircles bore 20c. As noted, first side 20a is configured for sealing against the flanged end face of a lined pipe with raised outer edge face 22 in contact with the pipe flange face 12a′ and recessed inner face 24 in contact with the liner flange face 14a′.

Faces 22 and 24 may each be substantially planar with face 22 defining a plane parallel to face 24. Put another way, ring 20 may have an outer wall, the flatted upper surface thereof being face 22 and the wall is raised around a planar annular portion defining face 24 in which bore 20c is positioned. As such, ring 20 may have a greater axial thickness between first side 20a and second side 20b around its outer edge, relative to a smaller axial thickness between first side 20a and second side 20b near bore 20c, and the thickness abruptly changes at the annular step 26.

Step 26 may be concentric with bore 20c but has a diameter greater than that of bore 20c. Step 26 may have a substantially consistent diameter from surface 22 to surface 24. The diameter at step 26 may be selected such that liner flange 14a may fit therein. That is, the diameter defined at step 26 may be equal to or greater than outer diameter of liner flange 14a. In use, the outer diameter of liner flange 14a may increase when under axial compression, which is commonly referred to as “creep” caused by plastic deformation due to axial compression between pipe flange 12a and flange-type component 16. Therefore, the amount by which inner diameter of step 26 is greater than the uncompressed outer diameter of liner flange 14a may be selected to permit only a desired degree of increase, creep, in the outer diameter of liner flange 14a. Limiting the degree of such creep prevents the liner flange 14a from degradation, thereby increasing its lifespan and reducing the incidence of failure. Permitting a limited degree of such creep of the liner flange may be useful so as to limit the degree of creep of the liner. Therefore in one embodiment, the diameter across step 26, which defines the outer diameter of recessed face 24, is only slightly larger than the diameter across the liner flange.

While the flanges may be standard with flat-faces, in this illustrated embodiment the pipe flange 12a may be of the type having a raised face, including a step 12a″. The step may be between a raised flanged face closer to the axis of the pipe, and a recessed flanged face further away from the axis. This style of flange allows machining of the sealing surface, such that the flanged face may be forged without thinning the actual flange. Step 12a″ may be in substantial radial alignment with step 26, such that raised outer edge face 22 may fit between step 12a″ and bolt 18.

As mentioned above, flange 12a is in contact with ring 20, specifically at surface 22. The ring thickness at surface 22, which is greater than the ring thickness at surface 24, ensures that the ring transmits the majority of compressive forces from face 12a′ to component 16 through the ring 20 at surface 22 rather than through the contact of flange 14a and surface 24. In particular, the ring limits compression to the plastic flange 14a while transmitting compressive forces arising from the flange bolts 18 through the connection. The thickness of ring at surface 22 relative to thickness of ring at surface 24 (i.e. the height of step 26) may contribute to how much compression is experienced, at least initially (e.g., on a new liner that has not experienced any wear and tear) between liner flange 14a and surface 24. In one embodiment, it may be useful to target a degree of compression between 8% and 12%, for example, 10%, for a new liner, measured at the liner flange. After wear and tear on the liner, this degree of compression may change. To achieve a desired degree of compression, factors such as the height of step 26 may be selected and/or adjusted.

To mitigate leakage, one or more o-ring glands 28 may be provided on the first side, for example on recessed inner face 24. Each o-ring gland 28 may have an o-ring placed therein to create a seal between ring 20 and liner 14. The one or more o-ring glands 28 may be concentric with each other, step 26, ring 20, and/or bore 20c.

The relative hardness of the materials of the assembly may contribute to the amount that each structure absorbs and/or transfers axial compression. The material from which the ring is constructed may be selected such that the material of the pipe (for example, metal, such as steel) is relatively harder than the material of the ring (for example, plastic), and the material of the ring is relatively harder than the material of the liner (for example, another plastic relatively softer than that of the ring). The o-ring, if present, may be made of a material that is softer than that of the liner and the ring. In such an embodiment, the ring material can withstand greater compressive loads than the liner flange and take stresses off the flange. The ring material may include one or more of stainless steel, nickel, and carbon steel. For example, the ring material may be nickel coated carbon steel. The ring, if made of softer materials, could yield substantially into a cone, disadvantageously contributing to an imbalance of pressure on the sealing interface. The material may be selected to be sufficiently hard to control compression of the interface pressure on the plastic flange dimensionally, while minimizing yielding of the ring.

Ring 20 is intended to be compressed between flange 12a and the opposite component 16, the ring outer diameter is limited to ensure that space is provided for bolts 18 to extend between flange 12a and the opposite component 16.

Bore 20c may extend axially from recessed inner face 24 of first side 20a to second side 20b of ring 20. The bore may have a consistent diameter from one end to the other or may have a diameter that increases or decreases along its length. For example, in one embodiment, it may be useful if the bore diameter tapers where the ring is to be placed between two structures with different inner diameters (such as between a lined pipe and an un-lined pipe). Such tapering may eliminate abrupt diameter changes and thereby reduce erosion caused by shoulders along the pipe flow path. In the illustrated embodiment of FIG. 7, for example, the diameter across bore increases towards second side 20b. The bore may have a cylindrical portion 20c′ with a constant diameter axially closer to recessed inner face 24, and a flared portion 20c″ axially closer to second side 20b. This flaring portion 20c″ along the bore diameter, where the diameter across the bore at face 24 is less than the diameter across the bore at second side 20b, may act to control stress flow in the ring.

As noted, the second side 20b may have various features. For example, the second side may be formed depending on the type of component 16 against which the ring 20 is sealed.

In one embodiment shown in FIGS. 8 and 9, sealing compression ring 820 may be configured to be couplable to a liner flange on each of its two sides. In other words, a first side 820a may be substantially the same as first side 20a described above, and a second side 820b of ring 820 may be a mirror image of first side 820a across a center plane orthogonal to the center axis of the bore 820c. In this illustrated embodiment, bore 820c may be substantially cylindrical, non-tapering. Alternatively, the bore may be tapered, for example, if each side of the ring is to be coupled to a differently sized liner. Each of first side 820a and second side 820b has a raised outer annular edge with face 822 thereon, a recessed inner face 824, a step 826 between the raised outer edge face 822 and recessed inner face 824, and one or more o-ring glands 828 in the recessed inner face.

FIGS. 1-7 illustrate an embodiment with first side 20a configured to seal against a lined pipe, while second side 20b has a non-recessed surface for sealing against a component 16 such as any of a standard flange, an end cap, a gasket (such as a spiral wound gasket 30, which may include a flat outer disk to centre the gasket, a relatively thicker portion containing a spiral element, and an inner plastic section to act as an initial seal) or even a lined pipe, although the embodiment of FIG. 8 would be preferred for that purpose.

In the embodiment of FIGS. 1-7, second side 20b defines an annular sealing surface that may be configured to distribute stress on the ring 20 caused by axial compression, thereby mitigating problems caused by concentrated stress on any given area of the ring. In such an embodiment, second side 20b of ring 20 may be generally convexly shaped. In the illustrated embodiment, for example, second side 20b has a beveled outer edge portion 29 such that the overall surface of second side 20b has a frustoconical shape at least on its outer circumferential edge. Second side 20b may include a relatively planar, flat inner portion 29′ between beveled edge portion 29 and bore 20c. Flat inner portion 29′ may, for example, define a plane substantially parallel to the plane of face 24. In such an embodiment, the flat inner portion encircles, and is substantially concentric with, bore 20c and the beveled edge portion 29 is the annular area between side wall 21 and the annular flat inner portion 29′. In one embodiment, the bevel at bevelled edge portion 29 substantially lines up with the location of step 26, which in other words means the diameter across step 26 is about the same as the outer diameter of flat inner portion 29′. The bevel at outer edge portion may be gradual such as sloping less than 45 and possibly less than 20 away from the planar surface of portion 29′.

### Clauses

Clause 1. A sealing compression ring apparatus couplable to a liner and a pipe component, comprising: a body, being substantially annular, having a first side, a second side, and a bore extending from the first side to the second side; the first side including: a raised outer edge portion; a recessed annular portion between the raised outer edge portion and the bore; and an o-ring gland encircling the bore on the recessed annular portion.

Clause 2. The apparatus of any one or more of clauses 1-7, wherein the bore has a tapered diameter that increases from the first side to the second side.

Clause 3. The apparatus of any one or more of clauses 1-7, further comprising an o-ring placed in the o-ring gland.

Clause 4. The apparatus of any one or more of clauses 1-7, wherein the o-ring is made of a material softer than that of the ring.

Clause 5. A pipe assembly, comprising: a base pipe including a flange having a planar face; a liner extending axially within the base pipe and extending radially out and over a portion of the flange to define a liner flange; an opposite flange surface connected by compression fasteners to the flange; and a sealing compression ring apparatus compressed between the flange and the opposite flange surface, the sealing compression ring including a body, being substantially annular, having a first side, a second side, and a bore extending from the first side to the second side; the first side including: a raised outer edge portion; a recessed annular portion between the raised outer edge portion and the bore; an o-ring gland encircling the bore on the recessed annular portion; and an o-ring positioned in the o-ring gland; the raised outer edge portion being in contact with the flange and the o-ring compressed between the liner flange and the recessed annular portion.

Clause 6. The assembly of any one or more of clauses 1-7, wherein the sealing compression ring is constructed of a material selected to be harder than that of the liner and softer than that of the base pipe.

Clause 7. The assembly of any one or more of clauses 1-7, further comprising an annular gasket positioned between the flange-type component and the second side of the sealing compression ring apparatus.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A sealing compression ring apparatus for a liner and a pipe component, comprising:
a body, being substantially annular and having a first side, a second side, and a bore extending from the first side to the second side;
the first side including:
a raised outer edge portion;
a recessed annular portion between the raised outer edge portion and the bore; and
an o-ring gland encircling the bore on the recessed annular portion.

2. The apparatus of claim 1, wherein the bore has a diameter that increases from the first side to the second side.

3. The apparatus of claim 1, further comprising an o-ring placed in the o-ring gland.

4. The apparatus of claim 4, wherein the o-ring is made of a material softer than that of the ring.

5. A pipe assembly, comprising:
a base pipe including a flange having a planar face;
a liner extending axially within the base pipe and extending radially out and over a portion of the flange to define a liner flange;
an opposite flange surface connected by compression fasteners to the flange; and
a sealing compression ring apparatus compressed between the flange and the opposite flange surface, the sealing compression ring including
a body, being substantially annular and having a first side, a second side, and a bore extending from the first side to the second side;
the first side including:
a raised outer edge portion;
a recessed annular portion between the raised outer edge portion and the bore;
an o-ring gland encircling the bore on the recessed annular portion; and
an o-ring in the o-ring gland;
the raised outer edge portion being in contact with the flange and the o-ring compressed between the liner flange and the recessed annular portion.

6. The assembly of claim 6, wherein the sealing compression ring is constructed of a material selected to be harder than that of the liner and softer than that of the base pipe.

7. The assembly of claim 6, further comprising an annular gasket positioned between the flange-type component and the second side of the sealing compression ring apparatus.
